(19) United States
(12) Patent Application Publication
(10) Pub. No.: US 2015/0217359 A1
(43) Pub. Date: Aug. 6, 2015

(54) Stacking Line System And Method For Stacking Blanks Outputted From A Blanking Shear Or Press

(71) Applicant: ABB TECHNOLOGY AG, ZURICH (CH)

(72) Inventors: Marc Segura Golorons, Sabadell (ES); Ramon Casanelles Moix, Sant Cugat Del Valles (ES)

(73) Assignee: ABB TECHNOLOGY AG, ZURICH (CH)

(21) Appl. No.: 14/407,905

(22) PCT Filed: Jun. 15, 2012
(86) PCT No.: PCT/EP2012/061414

§ 371 Date: Apr. 10, 2015

(51) Int. Cl. B21D 43/22; B65G 61/00; B25J 9/00; B65G 57/03

(52) U.S. Cl. CPC B21D 43/22; B65G 57/03; B65G 61/00; B25J 9/0084; Y10S 901/02

(57) ABSTRACT

It comprises a transfer unit for receiving the blanks; at least one stacking support for stacking blanks thereon; at least two industrial robots, said robots being arranged with respect to the transfer unit such that they are operable in at least an individual operating mode in which each robot picks a blank from the transfer unit in order to place it on a stacking support, and a joint operating mode in which a group of said robots act simultaneously on one and the same blank, to pick it from the transfer unit in order to place it on a stacking support; and robot control means adapted to operate the industrial robots in individual operating mode or in joint operating mode, depending on a parameter related to the size of the blanks, the weight of the blanks, the output rate from the blanking shear or press, and/or a combination thereof.

The present subject matter relates to a stacking line system which comprises a transfer unit for receiving the blanks outputted from a blanking shear or press, and stacking supports for stacking the blanks thereon.

### BACKGROUND

In the production of stamped or pressed metal parts, such as for example vehicle parts, presses may be supplied with metal blanks that have previously been cut from a metal coil in a separate blanking line. The blanks may be simple metal sheets of a predetermined length or have trapezoidal shapes (shear cutting by means of a blanking shear), or may present more complex outer shapes, cut-outs, etc. (shape cutting in a blanking press with a cutting die). More recently, also blanks with sawtooth edges may be produced with shears or presses.

Blanks produced in a blanking shear or press must be orderly stacked on stacking pallets, trolleys, carts or similar supports, in order to be later moved away from the stacking line and fed one by one to a press line or simply stored for later use or transportation to another production site. Using two pallets, trolleys or carts to stack the blanks allows continuous operation.

One aspect that must be taken into account in the stacking process is that the production rate of a blanking line is usually very high, particularly with parts of a relatively small size: for example, small blanks such as those having less than 1 m of length can easily achieve a rate of 60 blanks per minute, while blanks around 2-4 m of length can be outputted at a rate of 20 blanks per minute.

Other difficulties related to the stacking process are the variety of blanks of different materials, shapes, weights, output rates, etc. to which the process and system may need to be adapted, and the desired accuracy in the positioning of the blanks on the stacking pallet.

Traditionally the blanks are picked one by one after the outlet of the cutting die or shear and dropped on a stacking pallet by using magnetic and/or vacuum cup conveyor systems.

A blank is picked and hanged from a magnetic or vacuum conveyor system which transports it towards a centering position: here the blank is centered by a centering system and released by the magnetic or vacuum system to fall on a stack, and may need to be guided in this movement by a guiding unit, associated to each particular blank shape, so it reaches the correct position. The table or pallet on which the blanks are stacked is progressively lowered such that the blanks are released from a suitable height, regardless of the number of blanks that is already on the stack.

With such known systems it may be complex at least in some cases to provide the required centering; furthermore, it may be costly and/or time consuming to adapt such systems to a number of different blank sizes, weights, etc. because this adaptation may require significant changes.

The present subject matter aims to provide a stacking line system, or stacking blanks issued from a blanking shear or press, in which the above drawbacks are at least partly solved.

### SUMMARY

In a first alternative aspect, the developments hereof may provide a stacking line system for stacking blanks outputted from a blanking shear or press, said stacking line system comprising
a transfer unit for receiving blanks outputted from the blanking shear or press;
at least one stacking support for stacking blanks thereon;
at least two industrial robots,
   said robots being arranged with respect to the transfer unit such that they are operable in at least
      an individual operating mode in which each robot picks a blank from the transfer unit in order to place it on a stacking support, and
      a joint operating mode in which a group of at least two of said robots act simultaneously on one and the same blank, to pick it from the transfer unit in order to place it on a stacking support; and
a robot controller configured to operate the industrial robots in individual operating mode or in joint operating mode, depending on a parameter related to the size of the blanks, the weight of the blanks, the output rate of the blanks from the blanking shear or press, and/or a combination thereof.

The use of industrial robots operable in individual or in joint operating mode provides flexibility to the stacking line, since it can be adapted to a range of blanks of different sizes, weights, and output/transport rates, including blanks that could not be handled by a single robot of reasonable size, power and speed.

Furthermore, the changes that may be needed to adapt the line from one blank to another require less operations and shorter downtimes than in the case of a conventional magnetic or vacuum line, since there is no need to change the robots, and it is enough to adapt the guiding system, that may be very simple or even unnecessary. Some guiding may be required in the case of robots e.g. due to the effect of the air layer under the blank being stacked, that may cause a slight sideways movement when the blank is almost on the stack.

An additional advantage is that industrial robots are suitable to stack the blanks accurately in a simple way. For example it is unnecessary to provide a stacking table or pallet with a vertical movement, since robots may be operated to release each blank at the most suitable height.

By the expression “industrial robot” it is here meant an automatically controlled, reprogrammable, multipurpose, manipulator programmable in three or more axes, which may be either fixed in place or mobile for use in industrial automation applications, as defined by the International Organization for Standardization in ISO 8373.

In a further aspect, the subject matter hereof may provide a method for stacking blanks outputted from a blanking shear or press.

Additional objects, advantages and features of embodiments of the invention will become apparent to those skilled in the art upon examination of the description, or may be learned by practice of the invention.

### BRIEF DESCRIPTION OF THE DRAWINGS

Particular embodiments hereof will be described in the following by way of non-limiting examples, with reference to the appended drawings, in which:

FIG. 1 is a schematic drawing showing some examples of blank geometries that may be outputted from a blanking shear or press;

FIG. 2 is a perspective view of a stacking line system according to an embodiment hereof, with robots operating in individual mode;

FIG. 3 is a perspective view of the stacking line system of FIG. 1, with robots operating in joint mode,

FIG. 4 is a perspective view of a stacking line system according to another embodiment hereof, with robots operating in individual mode;

FIG. 5 is a perspective view of the stacking line system of FIG. 4, with robots operating in joint mode;

FIG. 6 is a perspective view of a stacking line system similar to that of FIGS. 2 and 3, with a different embodiment of transfer unit; and

FIG. 7 is a perspective view of a stacking line system similar to that of FIGS. 2 and 3, with a further different embodiment of transfer unit.

### DETAILED DESCRIPTION OF EMBODIMENTS

In a blanking shear or press blanks of rectangular or trapezoidal shape are cut by a shear from a metal coil; blanks with more complex shapes may also be formed by a contoured blanking die. These blanks are workpieces on which later on further operations may be performed, for instance in a press line. To this end, the blanks outputted from the blanking shear or press are stacked in a stacking line arranged adjacent the blanking shear or press.

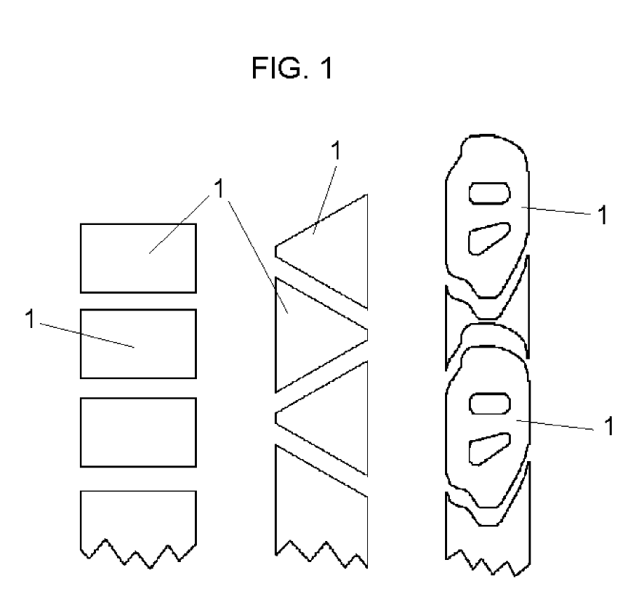

FIG. 1 shows by way of example some blanks 1 that may be outputted from a blanking shear or press.

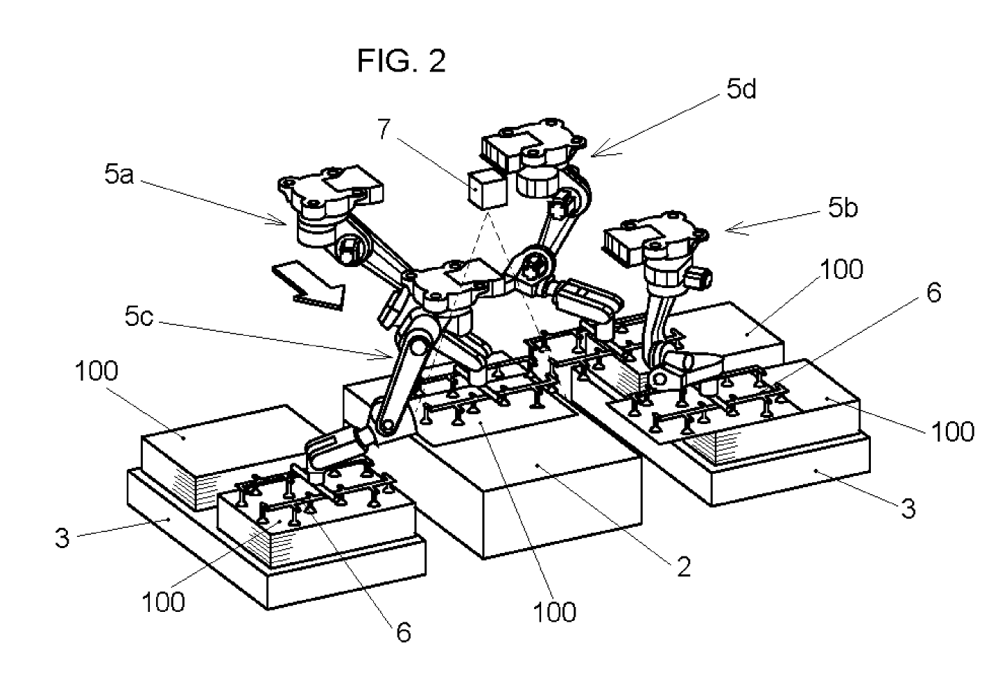

FIG. 2 shows a stacking line hereof, which may be arranged at the outlet of a blanking shear or press in order to stack the blanks that are outputted from the blanking shear or press on stacking supports.

More particularly, FIG. 2 shows schematically a transfer unit 2, which receives blanks 100 outputted from the blanking shear or press in the direction of the arrow, and from which industrial robots pick the blanks 100 in order to stack them, as will be described in the following.

The transfer unit 2 may e.g. be a stationary surface as shown in FIG. 2, where all the blanks are received and then picked in the same position; it may be a linear conveyor arranged to transport the blanks 100 along a transport path, from where they are picked by the robots. Further embodiments of the transfer unit 2 will be disclosed later on.

The system may also comprise stacking supports 3 for stacking blanks thereon, such that they can be later transported to another production line for further handling. The stacking supports 3 are also shown only schematically in the figures, because they may be of any known type.

At each side or above the transport path there may be two industrial robots, in this case two serial robots 5a, 5b, 5c, 5d, each with at least four axes (six rotational axes in FIG. 2). Each robot carries a tool 6 suitable for handling blanks 100, for example a known vacuum or magnetic tool.

As shown in the figure, the robots may be roof mounted, so as to be a smaller hindrance.

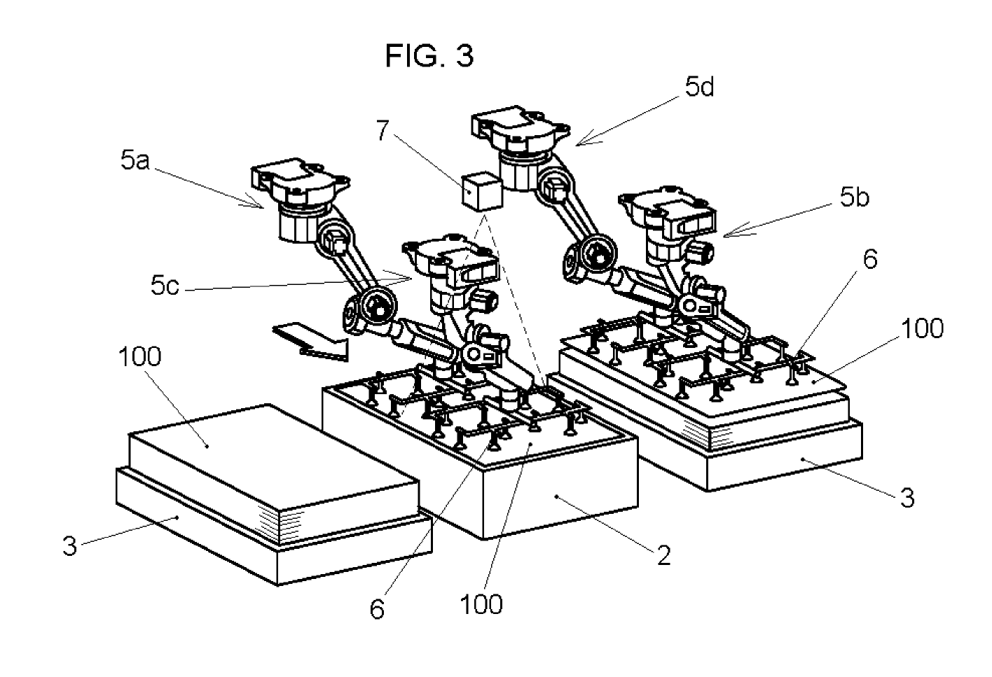

An example of a serial robot that may be employed in a stacking line system such as that of FIGS. 2 and 3 is robot IRB 6620, available from ABB (www.abb.com; Zurich, Switzerland).

Robots 5a, 5b, 5c and 5d may be controlled by a controller (not shown) to each pick a blank 100 from the transfer unit 2 and place it on an associated stacking support 3. This operation of the robots is herein referred to as “individual operating mode”.

This may be done in a predetermined sequence, e.g. as shown in FIG. 2, where:
robot 5a is picking a blank 100 from the transfer unit 2;
robot 5b has picked the previous blank 100 and is moving it towards its stacking support 3;
robot 5c is placing a blank on its associated stacking support 3; and
robot 5d has placed a blank 100 on its associated stacking support and is returning to pick the next blank.

The position on the transfer unit 2 where a blank is picked may be the same for all the robots 5a, 5b, 5c and 5d, or alternatively there may be different picking positions for different robots, for example if the transfer unit 2 is a linear conveyor.

In association to a picking position on the transfer unit 2 there may be an artificial vision unit 7, connected to the robot controller, such that the precise position of the blank may be known to the controller. This may ensure that each blank is picked from the transfer unit 2 and later placed on a stacking support 3 with the desired accuracy.

The artificial vision unit 7 may be located in the position where the blanks are received from the blanking shear or press; when the transfer unit is a conveyor the system may further comprise a known device, such as an encoder associated to the conveyor, to keep control of the position of a blank that advances on the conveyor. Each robot may thus pick up a blank in an appropriate position on the moving conveyor, and there is no need to stop the conveyor.

FIG. 3 shows transfer unit 2 and robots 5a, 5b, 5c, 5d in an operating condition which is suitable for larger and/or heavier blanks 200, wherein two robots are controlled by the controller to work jointly.

In this case, as shown in the figure, the pair of robots 5a, 5c on one side of the transfer unit 2, and the pair of robots 5b, 5d on the other side of the transfer unit 2 are controlled jointly, such that each pair of robots act simultaneously on one blank 200 to pick it from the transfer unit 2 and place it on a stacking support 3. This operation where two robots cooperate to move each blank is herein referred to as “joint operating mode”.

In FIG. 3, robots 5a and 5c are picking a blank 200 from the transfer unit 2, while robots 5b and 5d are placing the previously picked blank 200 on a stacking support 3.

Control units that may operate robots jointly are for example those available from ABB (www.abb.com; Zurich, Switzerland). which include the function MultiMove; MultiMove is a function embedded e.g. into ABB's IRC5 control module, that allows to control the axes of several manipulators such that they work like a single robot.

Examples of operation of the stacking line system are described in the following.

When relatively light and/or small blanks are produced in the blanking shear or press (not shown), for example 20 kg blanks which are outputted at a rate of 60 blanks per minute, the four robots 5a, 5b, 5c, 5d are operated in individual working mode, such that each of them picks and stacks one blank out of four outputted from the blanking shear or press.

This means each robot has to pick and stack 15 blanks each minute, and thus has 4 seconds for each blank. Since 20 kg is a relatively light weight, relatively small and fast robots may be employed in the system, which may be fast enough to work within this cycle time.

When heavier and/or larger blanks are produced in the blanking shear or press, for example 40 kg blanks, the output rate is typically smaller, for example 20 blanks per minute. In this case each pair of robots, i.e. robots 5a, 5b and robots 5c, 5d are operated in joint working mode as show in FIG. 3, such that each pair picks and stacks one blank out of two outputted from the blanking shear or press.

This means each pair of robots has to pick and stack 10 blanks each minute, and thus has 6 seconds for each blank.

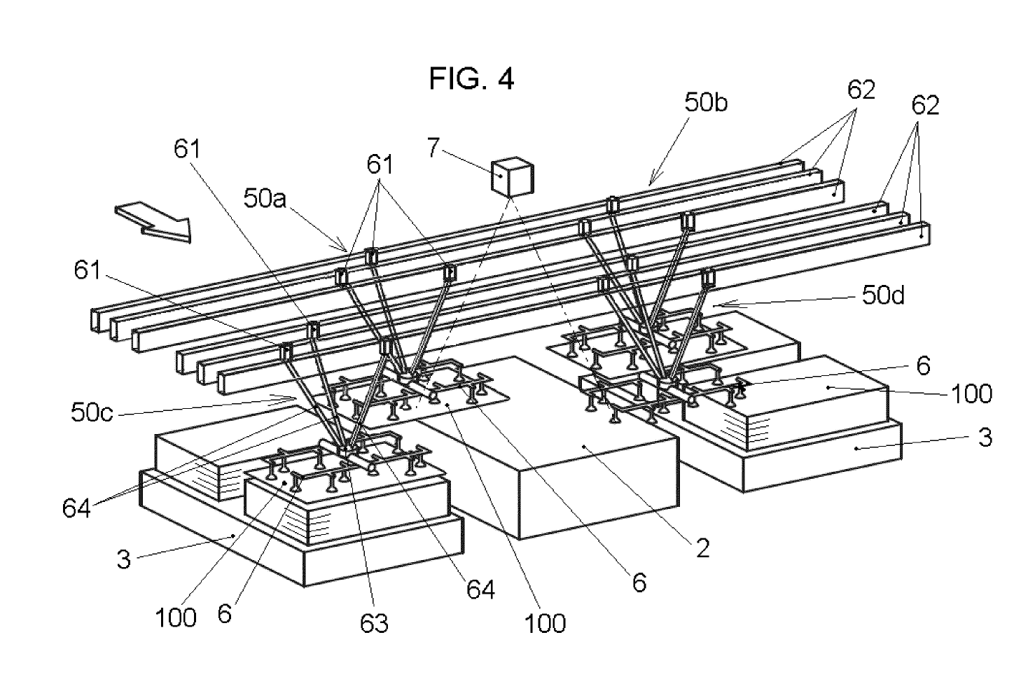

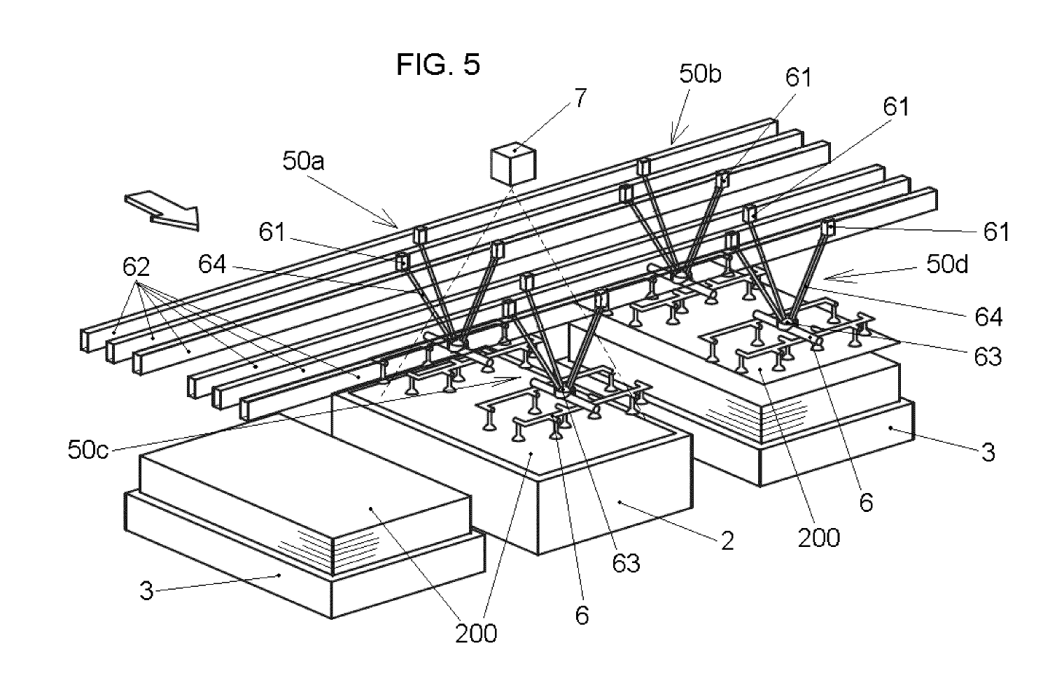

FIGS. 4 and 5 show schematically another embodiment of a stacking line system; in this case, parallel kinematic manipulators (PKM) are employed as industrial robots, instead of the serial robots of FIGS. 2 and 3. The features that are common to both embodiments have the same reference numerals, and are not described further.

FIG. 4 shows four parallel kinematic manipulators (PKM) 50a, 50b, 50c and 50d, working in an individual operating mode in which each PKM picks a blank 100 from the transfer unit 2 and places it on a stacking support 3, in sequence that may be similar to that performed by the serial robots of FIG. 2.

A parallel kinematic manipulator (PKM) is a low-inertia robot, which can be faster in operation than serial robots.

More particularly, PKMs are manipulators generally comprising a first stationary element, a second movable element and at least three arms. Each arm comprises a first arm part and a second arm part, the latter comprising a link arrangement connected to the movable element. Each first arm part is actuated by a driving device such as a motor, the driving device being preferably arranged on the stationary element to reduce the moving mass. The link arrangements transfer forces due to actuation of the supporting first arm parts when manipulating the wrist.

This design offers as high degree of load capacity, high stiffness, high natural frequencies and low weight.

As shown for the PKM having reference 50c in FIG. 4, each manipulator comprises in this example three carriages 61, each sliding with respect to one of three parallel tracks 62, driven by linear motors (not shown); the three carriages 61 are connected to a common wrist mount 63 by corresponding links 64, via spherical joints; the tool 6 for handling the blanks is attached to the wrist mount 63.

In this embodiment, the tracks 62 are the stationary element of the PKM, the wrist mount 63 is the movable element, and the carriages 61 and links 64 constitute respectively the two parts of the arms of the PKM.

It will be appreciated that by varying the position of the carriages 61 along their corresponding tracks, the wrist mount 63 may be displaced to a variety of positions in a fast and reliable way.

It has to be noted that in FIGS. 4 and 5 the PKMs are shown only very schematically; the structure, details and operating parameters of PKMs are known to the skilled man, who will be able to employ PKMs with the most suitable features for any particular application. For example, the links 64 of each PKM may be single, double, triple, . . . or a combination thereof; similarly, the layout of the tracks 62 may be decided on the basis of the positions that the wrist 63 needs to adopt and the space available in each particular application. The three tracks 62 of a PKM are parallel, but they don't need to be coplanar; they may also be arranged vertically, if suitable to the layout of the system.

In individual operating mode, the PKMs 50a to 50d follow a predetermined sequence in which, for example, as shown in FIG. 4:
PKM 50a is picking a blank 100 from the transfer unit 2;
PKM 50b has picked the previous blank 100 and is moving it towards its stacking support 3;
PKM 50c is placing a blank on its associated stacking support 3; and
PKM 50d has placed a blank 100 on its associated stacking support and is returning towards the transfer unit 2 to pick the next blank.

Like in the embodiment with serial robots, all the PKMs 50a, 50b, 50c and 50d may pick up blanks in the same position on the transfer unit 2, or in different picking positions.

The robots of FIG. 4 may also operate in joint operating mode, as shown in FIG. 5: the pair of robots 5a, 5c on one side of the transfer unit 2, and the pair of robots 5b, 5d on the other side of the transfer unit 2 are controlled jointly, such that each pair of robots act simultaneously on one blank 200 to pick it from the transfer unit 2 and place it on a stacking support 3. In the figure, robots 5a and 5c are picking a blank 200 from the transfer unit 2, while robots 5b and 5d are placing the previously picked blank 200 on a stacking support 3.

It should be noted that the PKM robots shown in FIGS. 4 and 5 may be replaced by any other suitable kind of PKMs; for example, they may be of the type disclosed for example in document WO03/066289, which have a first stationary element with one or more axes, and three or more arms. Each arm has a first arm part that rotates around one of said axes driven by a rotary motor, and a link connected between the first arm part and a wrist mount constituting the second moveable element.

This kind or PKM can also be roof mounted, with its main axis vertical or horizontal, as convenient is each particular case.

In both linear PKMs such as those of FIGS. 4-5 and rotational PKMs such as those of WO03/066289, the wrist mount may further include a degree of liberty of rotation and a corresponding actuator.

In the embodiments of FIGS. 2 and 3, for example, there are two robots arranged on each side of the transfer unit; however, in other embodiments, roof-mounted robots may be arranged above a blank transport path, substantially aligned with the transport path.

For example, when the transfer unit is a conveyor, four aligned robots may be arranged above the conveyor, such that in joint operating mode the first two robots in the transport direction operate together to pick a blank, and the third and fourth robots operate together to pick a blank.

The arrangement of the robots above a transport path may leave more space for the stacking supports on the sides of the transport path, such that it may be easier to arrange two stacking supports for each robot or group of robots.

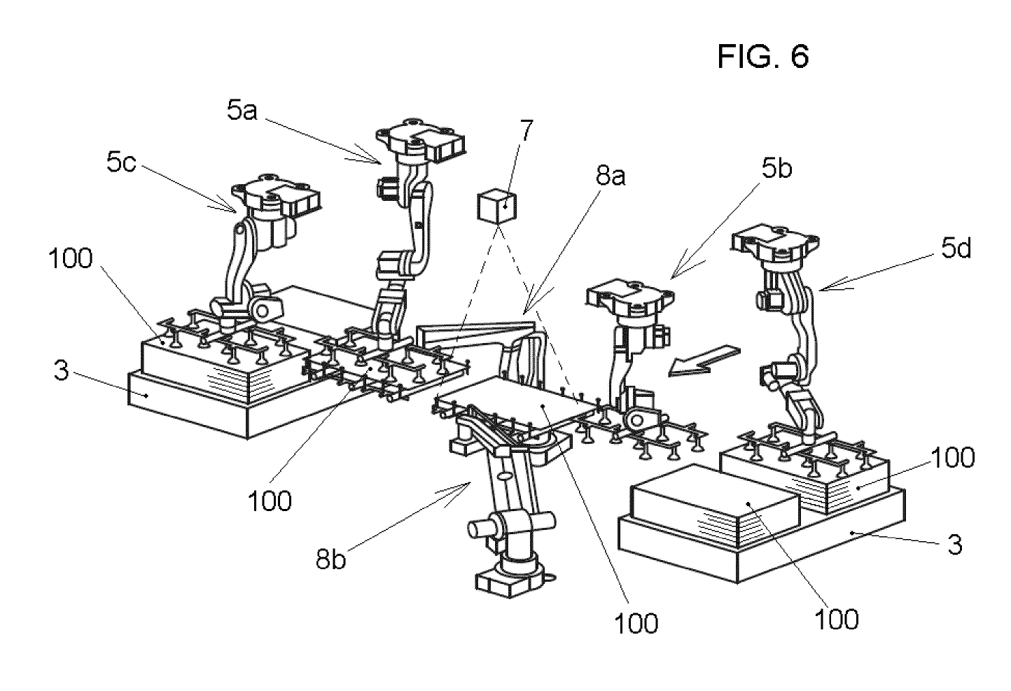

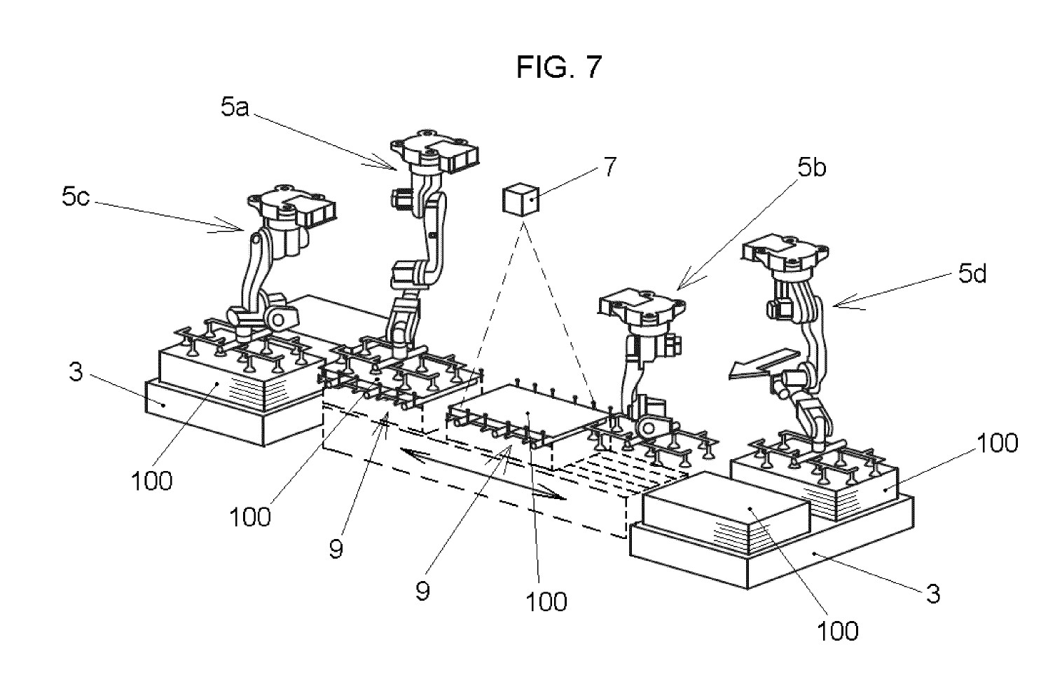

FIGS. 6 and 7 show two further embodiments of the transfer unit 2, applied to a stacking system that employs serial robots such as those of FIGS. 2 and 3.

In FIG. 6, instead of a stationary surface or a linear conveyor, the transfer unit 2 comprises two receiving robots 8a and 8b, such as for example 4-axes or 6-axes serial robots.

Each receiving robot 8a, 8b can move from a central, common reception position, where it receives a blank 100 outputted from the blanking shear or press, to a lateral delivery position: robot 8a is shown in the figure in its delivery position, while robot 8b is shown in the common reception position. The reception position for robot 8b is on the right of the figure with respect to this reception position.

As can be seen, the delivery positions of the two receiving robots 8a and 8b are different: robot 8a delivers a blank 100 in a position next to robots 5a and 5c, such that one of these robots (or both of them when working in joint mode) can pick it from the receiving robot 8a and place it on a stacking support 3, while robot 8b delivers the blank in a position next to robots 5b and 5d, on the other side of the stacking system.

In other embodiments, it may be foreseen that for example receiving robot 8a delivers blanks in two different positions, each associated to one of robots 5a and 5c, when the robots are working in individual mode. In some embodiments it may also be foreseen that in case of joint operating mode the two robots 8a and 8b work jointly to deliver one blank to the pair of robots 5a and 5c, and the following blank to the pair of robots 5b and 5d.

More generally, at least one receiving robot may be arranged to move from a reception position to at least one delivery position where one of the industrial robots, or a group of the industrial robots, picks the blank; the receiving robot may move to different delivery positions for different robots or groups of robots.

Commercial products that could be employed as receiving robot in such an embodiment are robots IRB 460 or IRB 660, available from ABB (www.abb.com; Zurich, Switzerland).

In the alternative embodiment of FIG. 7, which shows a stacking system similar to those of FIGS. 2, 3 and 6, the transfer unit 2 comprises a shuttle 9 which can reciprocate between a central reception position, where it receives a blank outputted from the blanking shear or press, and at least two different delivery positions, on either side of the central position; the industrial robots 5a, 5b, 5c, 5d, working in individual mode or in joint mode, pick the blank from the shuttle in one of the delivery positions.

FIG. 7 shows shuttle 9 both in the receiving position and in one of the delivery positions, and is depicted only very schematically.

In other embodiments the transfer unit may comprise two shuttles, such as shuttle 9 of FIG. 7, each travelling between a common central reception position, where they receive blanks issued from the blanking shear or cutting die, and two different delivery positions; one shuttle would serve robots 5a and 5c and the other would serve robots 5b and 5d.

In embodiments hereof, the shuttle or shuttles may be rotating units instead of linear units as in FIG. 7; in this case, each shuttle would rotate between a common reception position and one delivery position, if two rotating shuttles are employed, or alternatively a single shuttle would rotate between a reception position and two different delivery positions.

In another embodiment of the transfer unit, a shuttle with a dimension that is suitable for two blanks may be provided, and may move, e.g. reciprocate or rotate, between two positions, such that in each of said two positions one blank is received on the shuttle while another blank is picked from the shuttle by a robot or group of robots. That is, in a first position the right side of the shuttle is in a receiving position where it receives a blank, while the left side is in a delivery position where a robot may pick a blank that was previously placed thereon; in a second position the right side of the shuttle has moved to a delivery position to deliver said received blank, while the left side has reached the receiving position to receive a new blank.

According to embodiments hereof, a method for stacking blanks outputted from a blanking shear or press may comprise providing at least two industrial robots such as those disclosed above, and a suitable controller to operate the robots to pick blanks outputted from the line and place them on stacks; depending on a parameter related to the size of the blanks, the weight of the blanks, the transport rate of the blanks along a transport path, and/or a combination thereof, the industrial robots may be operated in an individual operating mode or in a joint operating mode as described above.

For example, the control may operate the robots in joint operating mode if a parameter such as the size of the blanks exceeds a preset value.

The controller may operate the robots or groups of robots in a predetermined sequence, such that all the blanks are picked from the transfer unit by the robots according to a predetermined in sequence.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. The scope of the present invention should not be limited by particular embodiments, but should be determined only by a fair reading of the claims that follow.

1. A stacking line system for stacking blanks outputted from a blanking shear or press, said stacking line system comprising
a transfer unit for receiving blanks outputted from the blanking shear or press,
at least one stacking support for stacking blanks thereon,
at least two industrial robots,
said robots being arranged with respect to the transfer unit such that they are operable in at least
an individual operating mode in which each robot picks a blank from the transfer unit in order to place it on a stacking support, and
a joint operating mode in which a group of at least two of said robots act simultaneously on one and the same blank, to pick it from the transfer unit in order to place it on a stacking support, and
a robot controller configured to operate the industrial robots in individual operating mode or in joint operating mode, depending on one or more of a parameter related to the size of the blanks, the weight of the blanks, the output rate of the blanks from the blanking shear or press, and/or a combination thereof.

2. The stacking line system as claimed in claim 1, wherein the groups of robots each include two robots.

3. (canceled)

4. The stacking line system as claims in claim 1, wherein at least part of the industrial robots are serial robots with at least 4 axes.

5. The stacking line system as claimed in claim 1, wherein at least part of the industrial robots comprise parallel kinematic manipulators each comprising a first stationary element, a second movable element and at least three arms, each arm comprising a first arm part actuated by a driving device and a second arm part, the latter comprising a link arrangement connected to the movable element.

6. The stacking line system as claimed in claim 5, wherein in at least part of the parallel kinematic manipulators the first stationary element comprises parallel tracks and the second movable element comprises a wrist mount, each arm comprising a carriage displaceable along one of the tracks and a link connected between the carriage and the wrist mount.

7. The stacking line system as claimed in claim 5, wherein in at least part of the parallel kinematic manipulators the first stationary element comprises at least one axis and the second movable element comprises a wrist mount, each arm comprising a first arm part rotatable around an axis of the first stationary element and a link connected between the first arm part and the wrist mount.

8. The stacking line system as claimed in claim 1, wherein at least part of the robots are roof-mounted.

9. (canceled)

10. The stacking line system as claimed in claim 8, wherein the transfer unit transports the blanks from a reception position along a transport path, the robots being arranged above the transfer unit and above the transfer unit and above said transport path, substantially aligned with the transport path.

11. The stacking line system as claimed in claim 1, comprising at least four industrial robots, at least two arranged on one side of the transfer unit and at least two arranged on the other side of the transfer unit, wherein a pair of robots on the same side of the transfer unit are operable together in joint operating mode.

12. The stacking line system as claimed in claim 1, comprising two stacking supports associated with each robot when said robots are set to operate in individual operating mode, the robots and stacking supports being arranged such that each robot is able to place blanks on either of its two associated stacking supports.

13. The stacking line system as claimed in claim 1, comprising two stacking supports shared by at least two robots when said robots are set to operate in individual operating mode, such that each robot is able to place blanks on both stacking supports.

14. The stacking line system as claimed in claim 1, comprising two stacking supports associated with each group of robots when said robots are set to operate in joint operating mode, the robots and stacking supports being arranged such that each group of robots is able to place blanks on either of its two associated stacking supports.

15-16. (canceled)

17. The stacking line system as claimed in claim 1, wherein the transfer unit comprises at least one receiving robot, each receiving robot being arranged to move from a reception position where it receives a blank from the blanking shear or press, and at least one delivery position where one of the industrial robots, or a group of the industrial robots, picks the blank from the receiving robot in order to place it on a stacking support.

18. The stacking line system as claimed in claim 17, wherein the transfer unit comprises two receiving robots, each receiving robot being arranged to move from a common reception position to at least one delivery position, the delivery positions of the two receiving robots being different.

19. The stacking line system as claimed in claim 17, wherein the receiving robots are 4-axes serial robots.

20. The stacking line system as claimed in claim 1, wherein the transfer unit comprises at least one shuttle arranged to move between a reception position and at least one delivery position, wherein the industrial robots, or the groups of the industrial robots, pick the blank from the shuttle in a delivery position in order to place it on a stacking support.

21. The stacking line system as claimed in claim 20, wherein the transfer unit comprises a shuttle arranged to move between a reception position and two different delivery positions, alternatively.

22. The stacking line system as claimed in claim 20, wherein the transfer unit comprises two shuttles, each arranged to reciprocate between a reception position that is common for the two shuttles and a delivery position, which is different for the two shuttles.

23-25. (canceled)

26. A method for stacking blanks outputted from a blanking shear or press, comprising:
providing at least two industrial robots, and a controller to operate the robots to pick blanks outputted from the line and place them on at least one stack, and
depending on one or more a parameter related to the size of the blanks, the weight of the blanks, the transport rate of the blanks along a transport path, and/or a combination thereof,
operating the industrial robots in an individual operating mode, in which each robot grips and picks a blank outputted from the line in order to place it on a stack, or
operating the industrial robots in a joint operating mode, in which a group of said robots act simultaneously to grip and pick one and the same blank outputted from the line in order to place it on a stack.

27. The method as claimed in claim 26, wherein the controller operates groups of two robots in joint operating mode if one or more of the parameter related to the size of the blanks, the weight of the blanks, the output rate of the blanks from the blanking shear or press, and/or a combination thereof, exceeds a preset value.
